(19) United States
(12) Patent Application Publication
(10) Pub. No.: US 2008/0210724 A1
(43) Pub. Date: Sep. 4, 2008

(54) Hand based support device for handheld implements and associated methods

(76) Inventors: Kelvin Geis, Provo, UT (US); Tyson David Triplett, Provo, UT (US)

Correspondence Address: THORPE NORTH & WESTERN, LLP., P.O. Box 1219, SANDY, UT, 84091-1219, US

(21) Appl. No.: 11/999,743

(22) Filed: Dec. 5, 2007

Related U.S. Application Data
(60) Provisional application No. 60/873,067, filed on Dec. 5, 2006.
(60) Provisional application No. 60/899,279, filed on Feb. 1, 2007.

(51) Int. Cl. B43K 23/012; B43L 15/00

(52) U.S. Cl. 224/217

(57) ABSTRACT

A hand based support device for holding a handheld implement on a user's hand. The support device includes a hand piece removably attachable to a user's hand. A coupler is associable with the handheld implement and magnetically coupleable with the hand piece to move the handheld implement between a usable position and passive support position.

### PRIORITY CLAIM

Benefit is claimed of U.S. Provisional Application No. 60/873,067 filed Dec. 5, 2006, and U.S. Provisional Application No. 60/899,279 filed Feb. 1, 2007, which are herein incorporated by reference in their entireties for all purposes.

### BACKGROUND OF THE INVENTION

Many activities require the use of both a computer keyboard and a handheld writing instrument, such as a pen, pencil, stylus, or the like. For example, graphics tablets have been developed that interact with computers to allow the input of graphical data into a computer by use of a handheld stylus. Such graphic tablet computer systems may also employ a keyboard for the input of alpha-numeric data into the computer.

Unfortunately, the handheld instrument is often set aside in order to allow the user to efficiently access and use the keyboard with two free hands. When this occurs the user must retrieve the handheld instrument in order to return to the hand writing or pointing activity. It will be appreciated that setting aside and retrieving the handheld instrument often results in a loss of productivity, especially when such motions are repeated many times.

### SUMMARY OF THE INVENTION

The present invention provides for a hand based support device for holding a handheld implement on a user's hand. The support device can include a hand piece removably attachable to a user's hand. The support device can also include a coupler associable with the handheld implement and magnetically coupleable with the hand piece to move the handheld implement between a usable position and passive support position.

### BRIEF DESCRIPTION OF THE DRAWINGS

FIG. 1 is a side view of a hand based support device in accordance with an embodiment of the present invention for holding a handheld implement on a user's hand;

FIG. 2 is a perspective view of the hand based support device of FIG. 1 shown with a coupler disposed on a handheld stylus;

FIG. 3 is a perspective view of the hand based support device of FIG. 1, shown with the coupler separated from a hand piece;

FIG. 4 is a perspective view of the hand based support device of FIG. 1, shown with the coupler disposed on the stylus and the hand piece disposed on a user's hand, and the stylus is oriented in a passive support position;

FIG. 5 is perspective view of the hand based support device of FIG. 1, shown with the coupler disposed on the stylus and the hand piece disposed on a user's hand, and the stylus is oriented in a usable position;

FIG. 6 is a side view of a hand based support device in accordance with another embodiment of the present invention shown with a coupler separated from a hand piece;

FIG. 7 is a side view of the hand based support device of FIG. 6 shown with the coupler magnetically attached to the hand piece;

FIG. 8 is a side view of a hand piece of a hand based support device in accordance with another embodiment of the present invention;

FIG. 9a is a side view of a coupler of a hand based support device in accordance with another embodiment of the present invention;

FIG. 9b is a side view of the coupler of FIG. 9a shown disposed on a handheld implement;

FIG. 9c is a perspective view of the coupler and a hand piece of the hand based support device of FIG. 9a, shown with the coupler disposed on a handheld implement;

FIG. 10 is a side view of a coupler of a hand based support device in accordance with another embodiment of the present invention;

FIG. 11 is a side view of a hand based support device in accordance with another embodiment of the present invention;

FIG. 12 is a side view of a hand based support device in accordance with another embodiment of the present invention;

FIG. 13 is a side view of a hand based support device in accordance with another embodiment of the present invention;

FIG. 14 is a side view of a hand based support device in accordance with another embodiment of the present invention;

FIG. 15 is a top view of a coupler of hand based support device in accordance with another embodiment of the present invention, shown coupled to a handheld implement;

FIG. 16 is a side view of a hand piece of a hand based support device in accordance with another embodiment of the present invention;

FIG. 17 is a side view of hand based support device in accordance with another embodiment of the present invention;

FIG. 18 is a perspective view of a hand based support device in accordance with another embodiment of the present invention;

FIG. 19 is a side view of a coupler of a hand based support device in accordance with another embodiment of the present invention;

FIGS. 20-27 are perspective views of a variety of hand pieces and couplers of a hand based support device in accordance with another embodiment of the present invention;

FIG. 28 is a perspective view of a hand based support device in accordance with another embodiment of the present invention;

FIG. 29 is a perspective view of the hand based support device of claim 1, shown disposed on a user's hand and positioning a handheld implement in a passive support position under the hand; and

FIG. 30 is a perspective view of the hand based support device of claim 1, shown disposed on a user's hand and positioning a handheld implement in a passive support position under the hand.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a hand based device for supporting a handheld implement, such as a pen, a pencil, a stylus, a laser pointer, a graphic tablet stylus, a touch screen stylus, a scribe, a hand writing device, a stick disk, a thumb drive, a flash memory drive, handheld medical devices, highlighters, markers, pen tablet stylus, and the like, on a user's hand. The hand based support device can position the handheld implement between a usable position engageable by the user's fingers and a passive support position out of the way of the user's fingers. The support device can have a hand piece, such as a finger ring or thumb ring that can be removably attached to the user's hand, and a coupler that can be associated with the handheld implement. The coupler can be attached to the handheld implement or can be an integral part of the handheld implement such as a body to a pen or stylus. The coupler can operably couple the handheld implement to the hand piece. The coupler can allow the handheld implement to move between the usable position and the passive support position and can operate to allow rapid placement and retrieval of the handheld implement from the passive support position.

In one embodiment, the hand piece can include a hand ring that can fit on the user's finger. The hand ring can include a magnetically attractive element, such as a magnet. The coupler can include a device ring that can fit on a handheld implement. The device ring can also include a magnetically attractive element. The magnetically attractive element of the device ring can be magnetically coupled to the magnetically attractive element of the hand ring such that the device ring can position a handheld implement in the usable and support positions depending on the orientation of the device ring with respect to the hand ring and the user's hand. In this way, the support device can allow the user to quickly, easily, and repeatedly access the handheld implement while minimizing conflict with other hand functions such as typing on a keyboard.

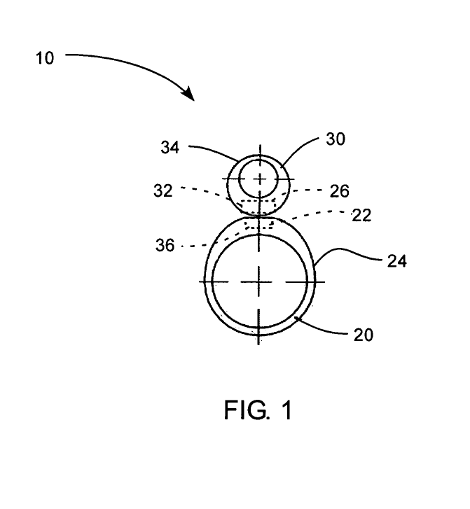

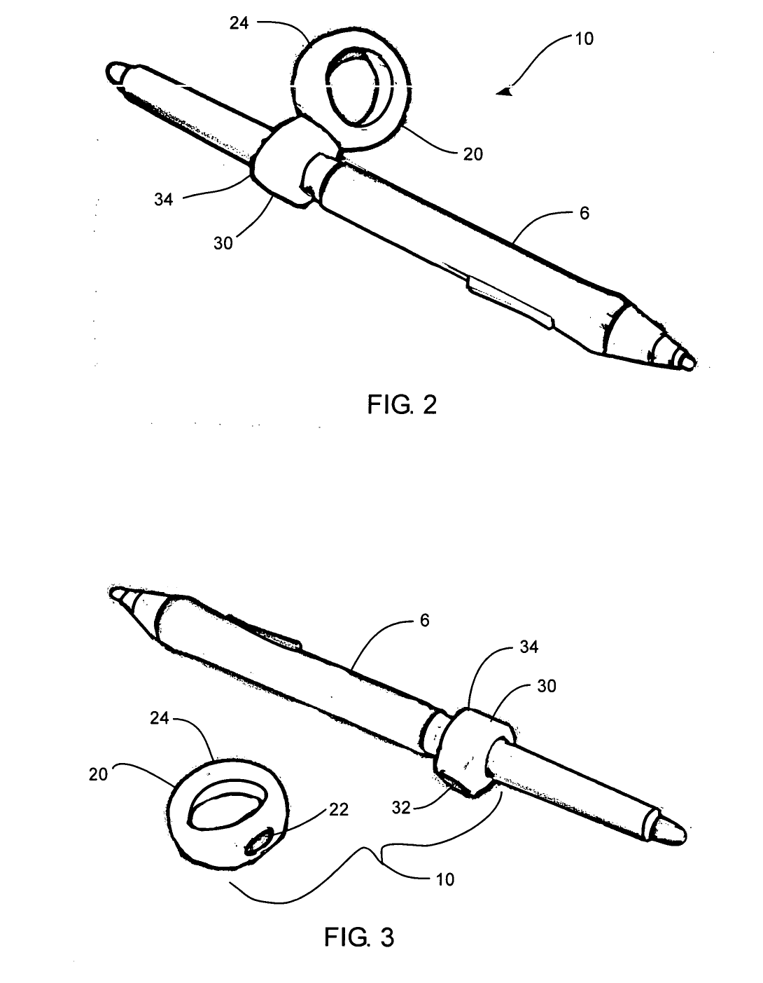

As illustrated in FIGS. 1-5, a hand based support device, indicated generally at 10, is shown in accordance with the present invention for holding a handheld implement 6 on a user's hand 8. The support device 10 can include a hand piece 20, and a coupler 30.

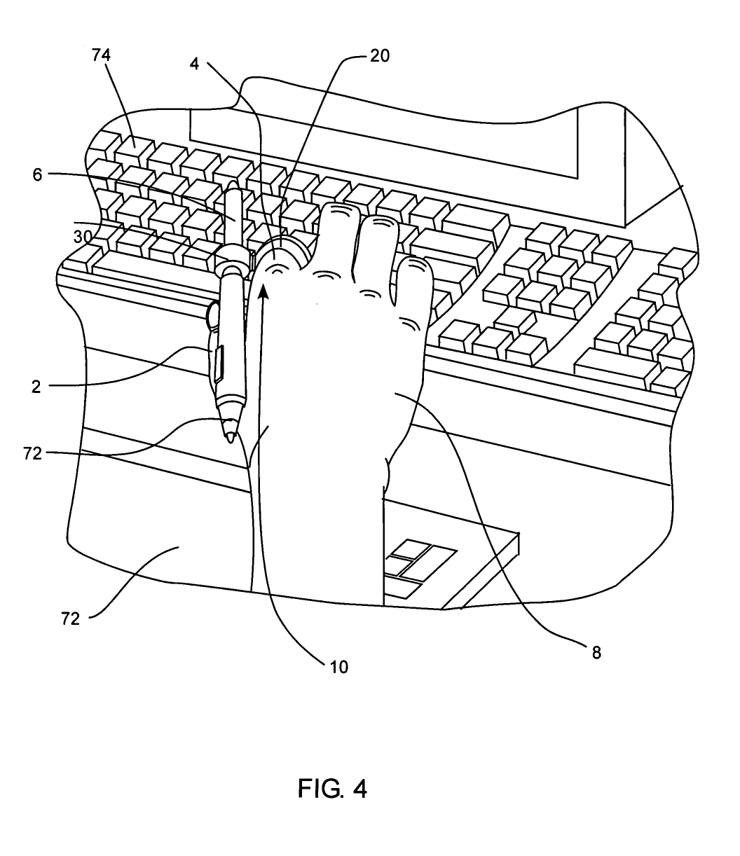

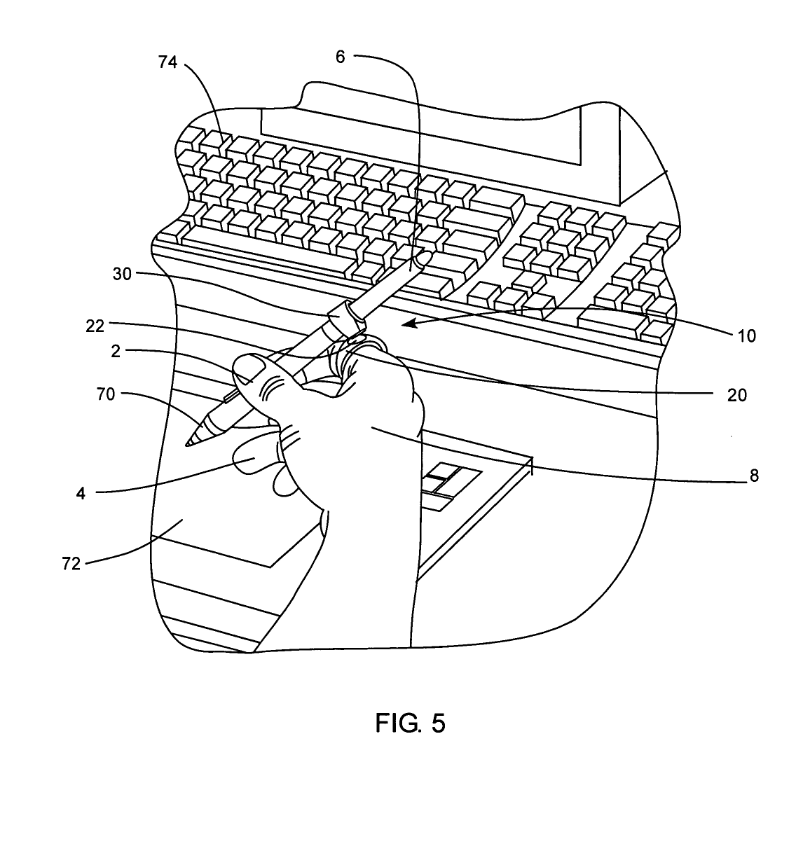

The hand piece 20 can be removably attachable to a user's hand 8. For example, the hand piece can be a ring 24 that is sized and shaped to fit on a user's finger 4 or the user's thumb 2. In one aspect, the hand ring 24 can be a self sizing ring that can adjust to fit the size one of the user's fingers or thumb. The hand ring 24 can rotatably attach to the coupler 30 so as to position the handheld implement 6 between a usable position engageable with the user's fingers, as shown in FIG. 5, and a passive support position out of the way of the user's fingers, as shown in FIG. 4.

It will be appreciated that a ring is one means for removably attaching the hand piece to the user's hand, and that other means, as known in the art, may also be used. For example, the hand piece 20 can include an attachment element such as a strap, a strap having hook and loop fasteners, a cord, an adhesive, a partial ring, a split ring, and the like.

Returning to FIGS. 1-5, the coupler 30 can be associable with the handheld implement 6. For example, the coupler can be a ring 34 that is sized and shaped to fit on the implement. In one aspect, the coupler ring 34 can be a self sizing ring that is sizable to fit a variety of different handheld implements. Thus, in the case where the implement is a stylus, pen, pencil or the like, the coupler ring 34 can fit around the body of the implement 6.

It will be appreciated that the coupler ring 34 is one means for associating the coupler 30 with the handheld implement 6, but other means, as known in the art, can also be used. For example, the coupler can be magnetically, mechanically, chemically, or adhesively attached to the implement. Thus, in one aspect, the coupler can be an outer body, shell or housing of the handheld implement that is formed of a magnetically attractable material such as a ferrous metal. In another aspect, the coupler can be a magnet glued to the body of the handheld implement.

It is a particular advantage of the present invention that the coupler 30 allows the user to position the handheld implement 6 in a passive support position so as to reduce inadvertent contact between the implement and the user's fingers 4. Additionally, the coupler 30 can advantageously be associable with a wide variety of handheld implements. Such handheld implements can include pens, pencils, markers, dry erase markers, highlighters, chalks, erasers, glue sticks, drafting tools, sewing needles, paperclips, computer touch screen stylus, Pen-Tablet stylus, keys, small hand tools, a digitizing stylus, or pressure sensitive stylus for computer interfacing, small handheld medical instruments, and the like.

The coupler 30 can also be operably coupleable with the hand piece 20 to move the handheld implement 6 between the usable position and passive support position. In the useable position, the implement can be accessed by the fingers such that the fingers can grasp the handheld implement in a natural writing or pointing position, as shown in FIG. 5. In the passive support position, the implement can be located substantially on the back or side of the hand so as to reduce inadvertent contact between the implement and the fingers, as shown in FIG. 4.

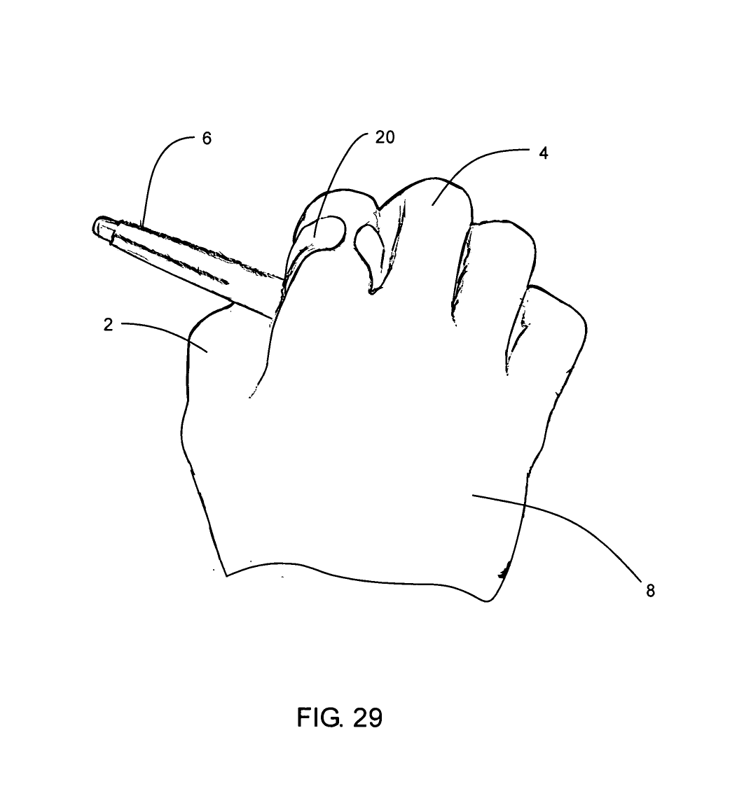

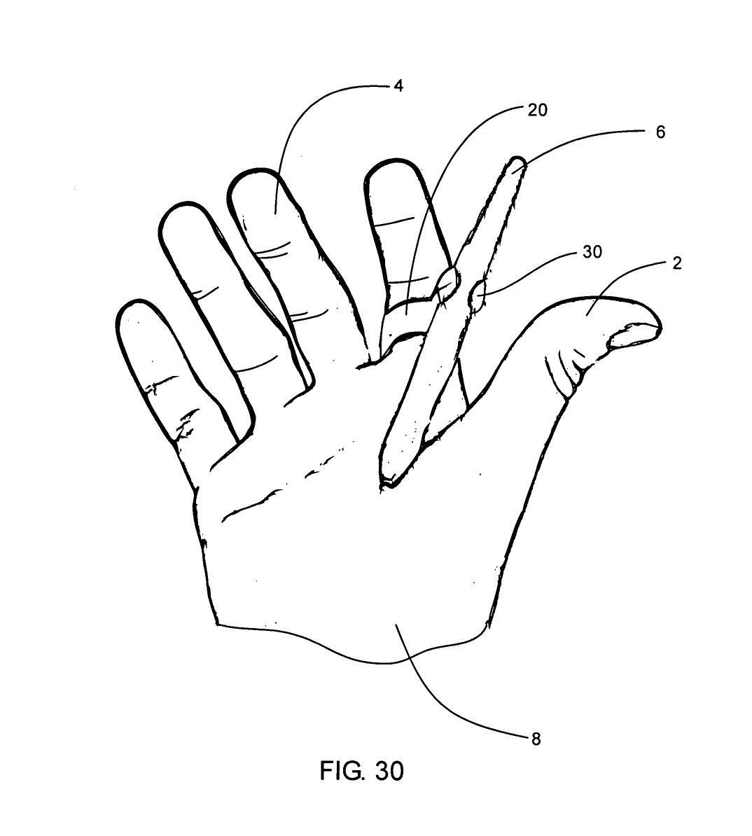

An additional passive support position can locate the handheld implement 6 substantially under the hand 8 adjacent the palm and oriented substantially perpendicular to the user's fingers 4, as shown in FIG. 29. Another additional passive support position can located the handheld implement 6 substantially under the hand 8 adjacent the palm and oriented substantially parallel to the user's finger 4, as shown in FIG. 30

Advantageously, the handheld implement 6 can be rotated between the usable position and the passive support position by the fingers 4 or hand 8 that has the support device 10 attached thereto. For example, the handheld implement 6 can be rotated by engaging the handheld implement with the user's thumb 2 on the same hand that has the hand piece 20 attached. The thumb 2 can spin or rotate the handheld implement 6 and the coupler 30 about the magnetic element 22 in the hand piece 20. Additionally, as another example, the handheld implement 6 can be rotated by quickly rotating or flicking the wrist of the hand that has the support device 10 attached. A quick flick of the wrist can spin or rotate the handheld implement 6 and the coupler 30 about the magnetic element 22 in the hand piece 20. In this way, rotating the handheld implement between the usable position and the passive support position can be accomplished with one hand thereby leaving the other hand free to accomplish other tasks. Thus, the support device 10 can advantageously be used to facilitate multitasking in a wide variety of environments and professions. For example, the support device 10 can facilitate multitasking for graphic artists, who regularly use both a graphics tablet and a keyboard, and nurses who regularly work with medical devices, write on charts, and type on computers. Many other multitasking jobs can also benefit from the advantages of the support device 10 of the present invention.

Returning to FIGS. 1-5, both the hand piece 20 and the coupler 30 can be formed from a polymer material. For example, the hand piece 20 and the coupler 30 can be formed of hardened polyurethane or polyolefin in molding process such as injection molding. As another example, the hand piece 20 and the coupler 30 can be formed of a strip of foam material that is adhesively connected at distal ends to form a ring shape. Other suitable materials, such as metal, wood, plastic, and the like can also be used to form the hand piece and the coupler. Additionally, other fabrication processes such as casting, sculpting, carving, and the like, can be used to manufacture the rings.

The coupler 30 can be magnetically coupleable with the hand piece 20. For example, the hand piece 20 can include a magnetically attractable element 22 and the coupler 30 can include a corresponding magnetically attractable element 32. The hand piece magnetic element 22 can be a primary magnetic element, such as magnet, and can be magnetically attractable to the magnetic element 32 in the coupler 30, which can be a secondary magnetic element. Advantageously, having a magnet attached to the handheld implement allows the implement to be coupled to other magnetic surfaces such as a desk-lamp, whiteboard, refrigerator or any other magnetically attractive surface when not being used by the user.

Thus, in one embodiment, the hand piece magnetically attractable element 22 can be a magnet 26, such as a neodymium magnet, and the coupler magnetically attractable element 32 can include a magnetic attractable material, such as a ferrous based metal. In this case, the coupler magnetic element 32 can be included in a ring, disposed under a body of the handheld implement, or be an outer casing or shell forming the body of the implement and enclosing the implement.

In another embodiment, the hand piece magnetically attractable element 22 can include a magnetically attractable material, such as a ferrous based metal, and the coupler magnetically attractable element 32 can be a magnet 36, such as a neodymium magnet. In yet another aspect, the hand piece magnetically attractable element 22 can be a magnet 26, and the coupler magnetically attractable element 32 can be a magnet 36, and the magnets can be oriented to attract one another.

In use, the user can place the hand piece 20 on a finger 4 or thumb 2. The coupler 30 can be placed on the handheld implement 6. The user can then engage the implement 6 with his fingers 4. For example, in the case the implement 6 is a graphic tablet stylus 70, the user can use the stylus to input data on the graphics tablet 72, as shown in FIG. 4. When the user wants to use the keyboard 74, the user can position the coupler 30 near the hand piece 20 such that the magnet 32 on the coupler is attracted to and magnetically attaches to the magnet 22 on the hand piece. With the coupler 30 magnetically coupled to the hand piece 20, the user can rotate the stylus 70 around so the stylus is positioned substantially on the back of the user's hand 8 and out of the way of the user's fingers 4, as shown in FIG. 5. In this way, the hand piece 20 can receive the coupler 30 and position the handheld implement 6 in the passive support position so as to reduce inadvertent contact with the user's fingers.

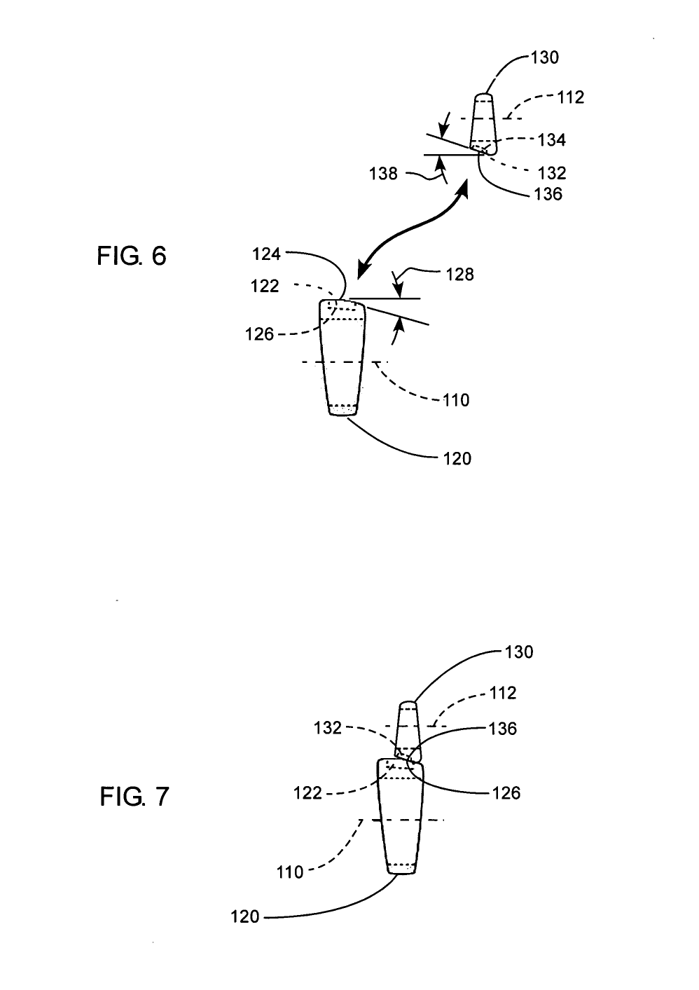

As illustrated in FIGS. 6-7, a hand based support device, indicated generally at 100, is shown in accordance with another embodiment of the present invention for holding a handheld implement 6 on a user's hand 8. The hand based support device 100 can be similar in many respects to the hand based support device 10 described above and shown in FIGS. 1-5. The support device 100 can include a hand piece 120 with a magnet 122, and a coupler 130 with a magnet 132.

The magnet 122 can be disposed in a recess 124 formed in a face 126 of the hand piece 120. Similarly, the magnet 132 can be disposed in a recess 134 formed in a face 136 of the coupler 130. The face 126 and magnet 122 of the hand piece 120 can be oriented at an oblique angle 128 with respect to an axis 110 of the hand piece 120. Similarly, the face 136 and magnet 132 of the coupler 130 can be oriented at an oblique angle 138 with respect to an axis 112 of the coupler 130. It will be appreciated that the angle on the magnets will orient the handheld implement at a particular angle with respect to the user's hand. Advantageously, such an oblique angle between the hand piece magnet 122 and the coupler magnet 132 allows the handheld implement 6 to twist into a more accessible position to the fingers of the user's hand so as to enable quick retrieval of the implement.

One advantage of the present invention that the handheld implement can be positioned away from the fingers in the passive support position. This allows the user to engage in a number of activities that involve both hands without interference from the handheld implement. Such activities may include common hand functions and operations such as typing, computer keyboard and mouse usage, phone usage, paper shuffling, turning bound pages, retention of paper clips while copying, etc.

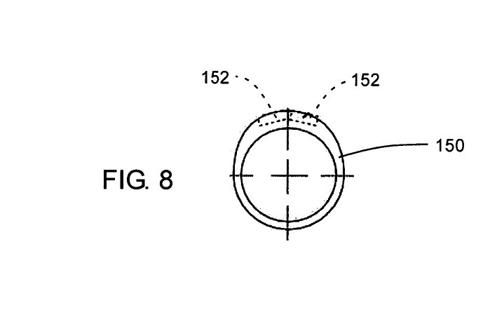

As illustrated in FIG. 8, in another embodiment the hand piece 150 can include a plurality of magnetic elements 152 with each element oriented at a different angle with respect to the other magnets 152 on the hand piece. In this way, the couplers 30 and 130 can be positioned on any of the plurality of magnets 152 of the hand piece 150 in order to achieve a desired angle of repose for the handheld implement.

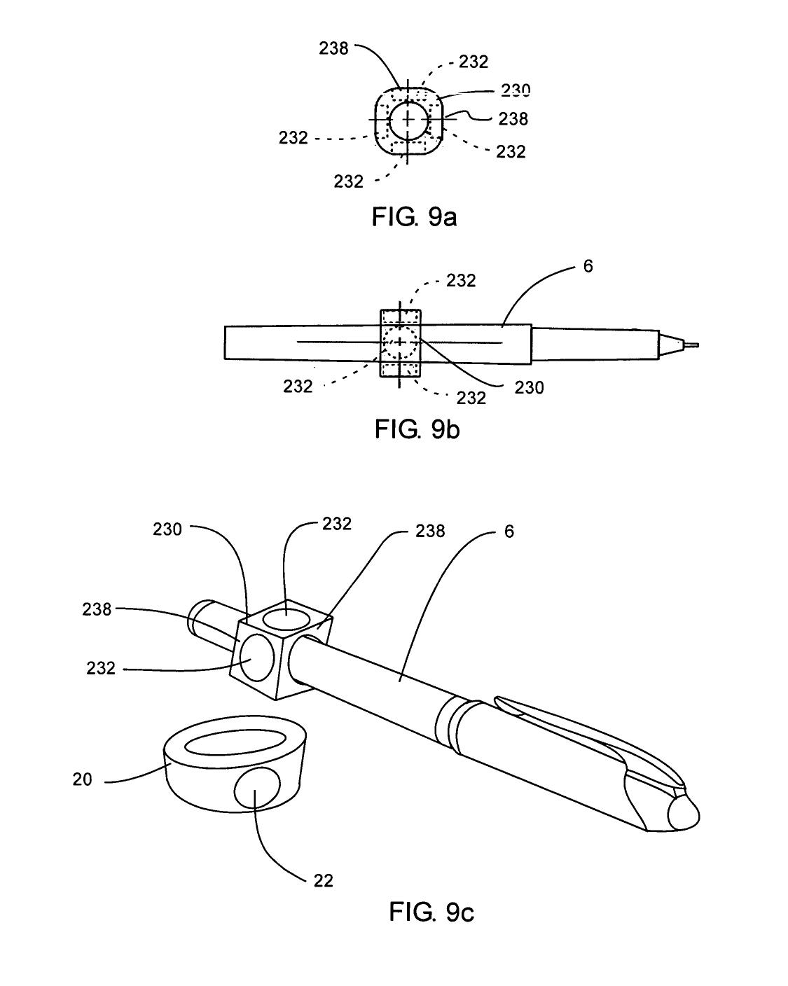

Referring to FIG. 9, in another embodiment, the coupler 230 can include a plurality of magnets with each magnet 232 disposed at a different angle with respect to the other magnets on the coupler. For example, the magnets 232 can positioned on different sides 238 of the coupler 230 so that in one aspect, the coupler 230 can be substantially quadrangular, with a magnet disposed on each side of the quadrangular shape, as shown in FIGS. 9a-9c.

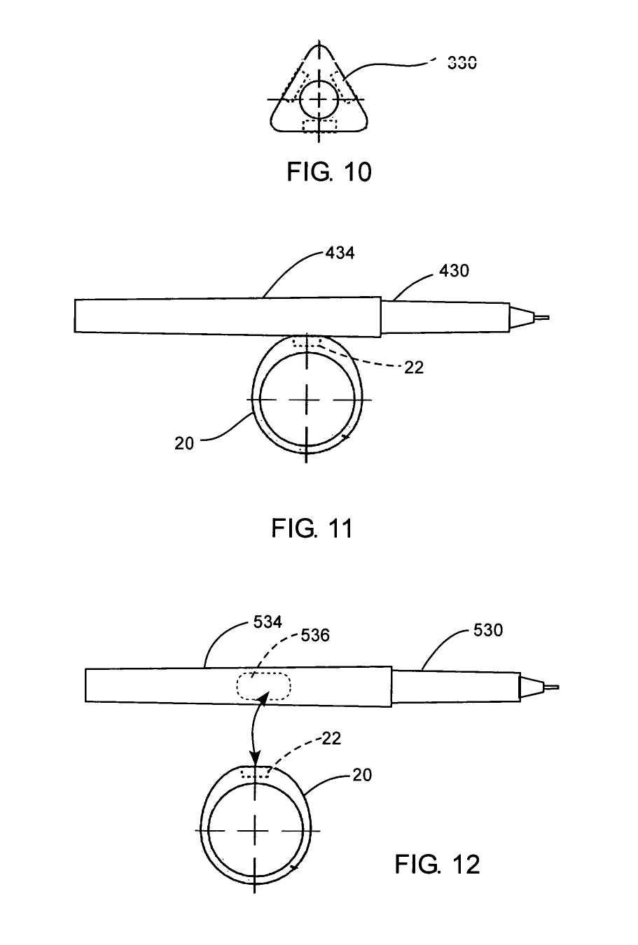

Referring to FIG. 10, in another embodiment, the coupler 330 can be substantially triangular, as shown in FIG. 10. In this way, the coupler can be positioned on any of the plurality of magnets in order to achieve a desired angle of repose for the handheld implement.

Referring to FIG. 11, in yet another embodiment, the coupler 430 can include a shell 434 substantially encasing the handheld device. The shell 434 can form the body of the handheld implement. The shell 434 or body can be made from a magnetically attractive material and can magnetically couple to the hand piece.

Referring to FIG. 12, in yet another embodiment, the coupler 530 can include a magnet 534 held on the inside of an encasing shell 536. The encasing shell 536 can form the body of the handheld implement such that the magnet 534 is disposed under the body of the implement. The magnet 534 can magnetically couple with a magnet on the hand piece.

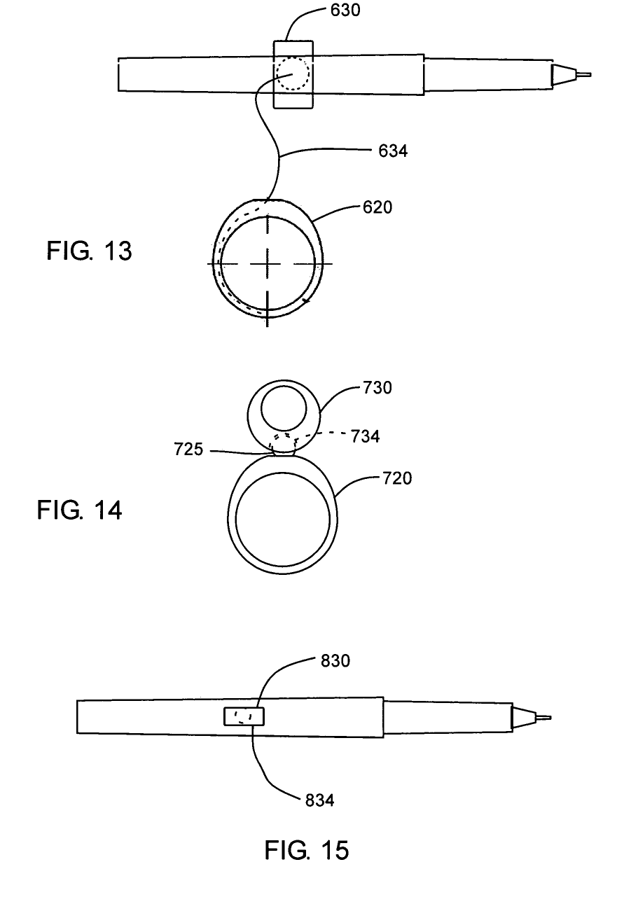

It will be appreciated that magnetic elements are but one way to operably couple the hand piece and the coupler, and that other coupling devices, as known in the art can also be used. For example, as shown in FIG. 13, the coupler 630 can include a spring loaded tether 634 extending between the hand piece 620 and the coupler. In another example, as shown in FIG. 14, the hand piece 720 can include a ball 724 and the coupler 730 can include a socket 734 so that an operable mechanical coupling exists between the hand piece and the coupler. As yet another example, the coupler 830 can include a bracket 834 coupleable by an adhesive onto the handheld device, as shown in FIG. 15. The bracket can be configured to receive the hand piece.

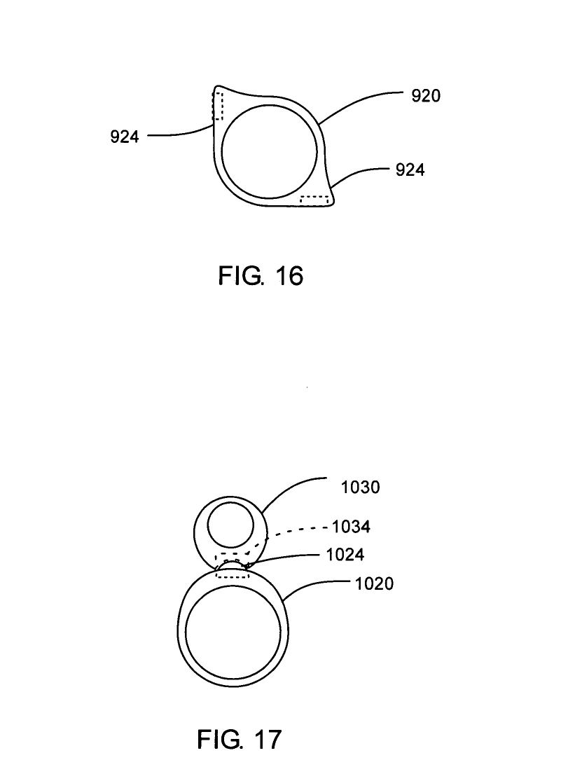

Referring to FIG. 16, in yet another embodiment, the hand piece 920 can include a ring 926 with flanges 924 that extend outward from the ring. The flanges 924 can be engaged to rotate the ring on the user's finger in order to position the hand piece 920 to receive the coupler. Advantageously, the flanges 924 can be accessed by the fingers on the same hand that has the hand piece. It will be appreciated that similar flanges may also be included on the coupler so as to facilitate rotation of the coupler with respect to the hand piece.

Referring to FIG. 17, in yet another embodiment, the hand piece 1020 and coupler 1030 can include shaped magnets 1024 and 1034 that are shaped so as to facilitate placement of the handheld implement in the passive support position. For example, the magnets 1024 and 1034 can have a spherical shape that can pull the coupler 1030 into contact with the hand piece 1020 and resist displacement of the coupler from the hand piece. Additionally, the magnets 1024 and 1034 can have other shapes such as triangular, rectangular or square shapes.

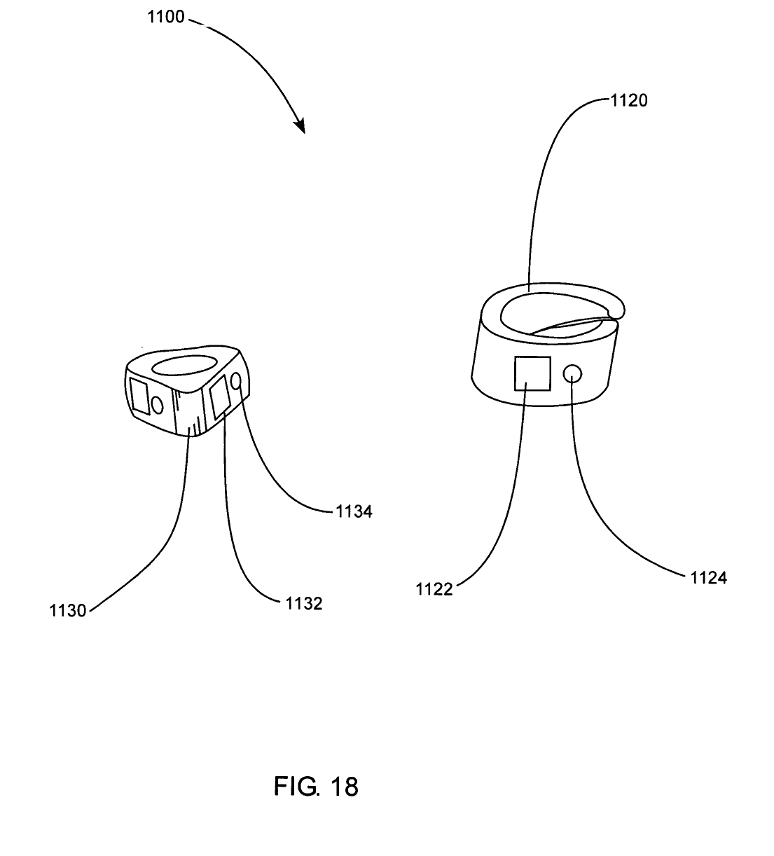

As illustrated in FIG. 18, a hand based support device, indicated generally at 1100, is shown in accordance with another embodiment of the present invention for use in holding a handheld implement, such as a pen, stylus, pencil or the like, on a user's hand. The hand based support device 1100 can be similar in many respects to the hand based support devices described above and shown in FIGS. 1-17. The hand based support device 1100 can have a hand piece 1120 removably attachable to a user's hand, and a coupler 1130 rotatably and removably coupleable to the handheld piece.

Additionally, the hand piece 1120 can include a magnetically attractable attachment element 1122 and a magnetically attractable alignment element 1124. The hand piece attachment element 1122 and the hand piece alignment element 1124 can have opposite magnetic poles. Additionally, the attachment element 1122 can have a greater magnetic attractive force than the magnetic attractive force of the alignment element 1124.

Similarly, the coupler 1130 can include a magnetically attractable attachment element and a magnetically attractable alignment element. The coupler attachment element 1132 and the coupler alignment element 1134 can have opposite magnetic poles. Additionally, the attachment element 1132 can have a greater magnetic attractive force than the magnetic attractive force of the alignment element 1134.

The coupler attachment element 1132 can correspond in position and alignment to the hand piece attachment element 1122 and the coupler alignment element 1134 can correspond in position and orientation to the hand piece alignment element 1124. Thus, the attachment element 1122 in the hand piece 1120 can be magnetically attachable to the attachment element 1132 in the coupler 1130, and the alignment element 1124 in the hand piece 1120 can be magnetically attachable with the alignment element 1134 in the coupler 1130.

Additionally, the magnetic poles of the attachment elements and the alignment elements can correspond such that when the hand piece and the coupler are coupled together the attachment elements attract one another and the alignment elements attract one another. In this way, the coupler can be alignable on the hand piece with the alignment elements aligned and the attachment elements aligned, thereby aligning a handheld implement associated with the coupler in the passive position.

Moreover, the greater magnetic force of the attachment elements than the magnetic force of the alignment elements can facilitate rotation of the hand piece and coupler about the attachment elements when coupled together in order to misalign the alignment elements but retain coupling of the attachment elements. In this way, the coupler can be oriented in the use position such that the handheld implement can be grasped and used by the user's hand.

Thus, the present invention can provide specific benefits to those who suffer from hand injuries or diseases such as arthritis, carpal tunnel syndrome and the like since the device keeps the handheld implement in an easily accessible location. It will be appreciated that those that suffer from arthritis, carpal tunnel and other hand maladies, often have limited movement of the hand or fingers due to limitations on their range of motion and pain caused by movement. Advantageously, the present invention can keep a handheld implement on the hand and very close to the user's fingers so that the user does not need to move their fingers or hand very far to retrieve the handheld implement.

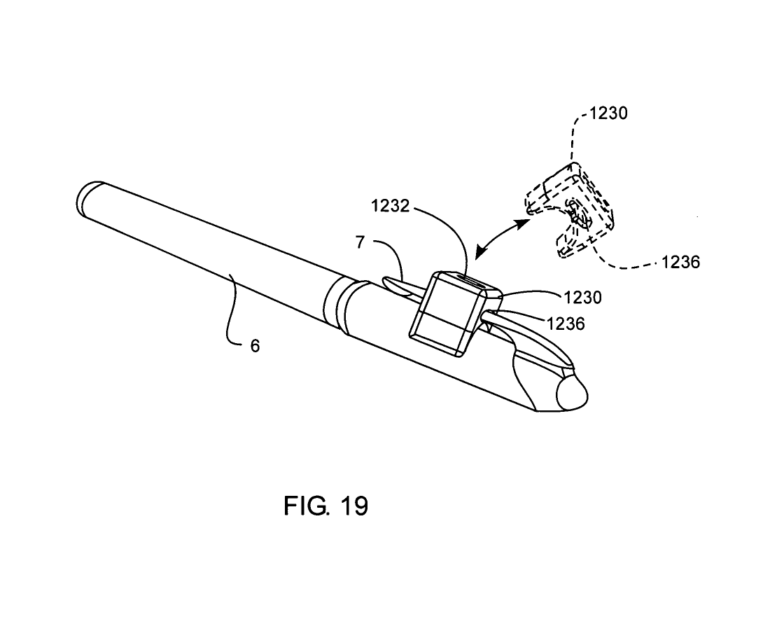

As illustrated in FIG. 19, another embodiment of a handheld implement coupler, indicated generally at 1230 is shown for use in coupling a handheld implement to a hand piece of a hand based support device as described above. The coupler 1230 can be configured to attach to an existing pocket clip 7 of the handheld device. It will be appreciated that the many handheld implements such as pens, pencils and the like, have clips that can be attached to the pocket of the user. The coupler can include a magnetically attractable element 1232. Additionally, the coupler 1230 can include a pocket clip recess 1236 configured to attach to the pocket clip 7 of the handheld implement.

It will be appreciated that the concepts of the present invention also provide for other configurations that improve aesthetic and functional aspects of the hand based support device. For example, the magnetically attractable elements can be embedded below surface of the hand piece and/or coupler in order to provide more aesthetically appealing mating surfaces. Additionally, the hand piece and/or coupler can be manufactured from a dual injection process of harder materials to accommodate the pivot points of the magnetically attractable elements, and softer more pliable materials for the hand piece.

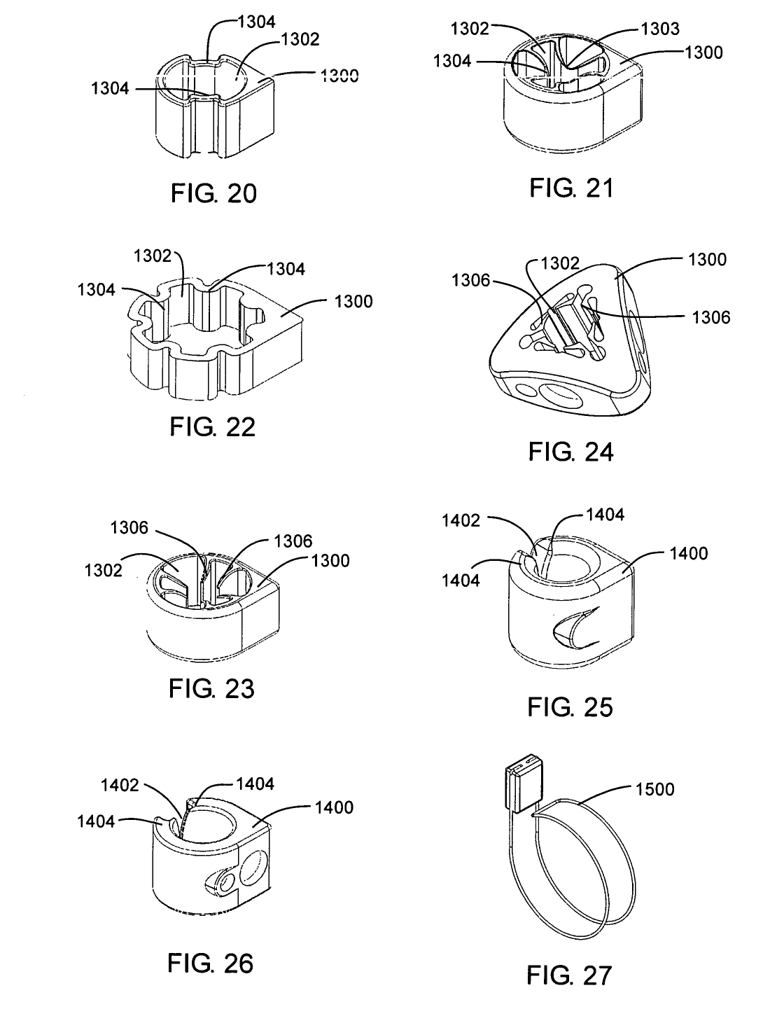

The hand piece and coupler can also be sizable rings 1300 to fit many sizes of both user's fingers and handheld implements, as shown in FIGS. 20-27. For example, the inside diameter 1302 of the ring 1300 can be configured to allow the addition of sizing rings 1304 to make the inside diameters smaller or larger as desired, as shown in FIGS. 20-22. In another example, the inside diameter 1302 can have a plurality of flexible fingers 1308 extending into the ring 1300 that can deform to the shape of the finger or handheld implement inserted into the ring 1300, as shown in FIGS. 23-24. In yet another example the ring 1400 can have a split 1402 to allow the diameter to be larger or smaller by opening or closing a gap between ends 1404 of the ring, as shown in FIGS. 25-26. In yet another example, the ring 1500 can be formed of a bendable wire that can be sized to the desired diameter, as shown in FIG. 27. Advantageously, the bendable wire can be formed of a metal alloy having shape memory characteristics, such as nitinol. Alternatively, the inside diameter of the hand piece and/or coupler can have a double radius to facilitate ease of removal and positioning on various finger and pen sizes and shapes.

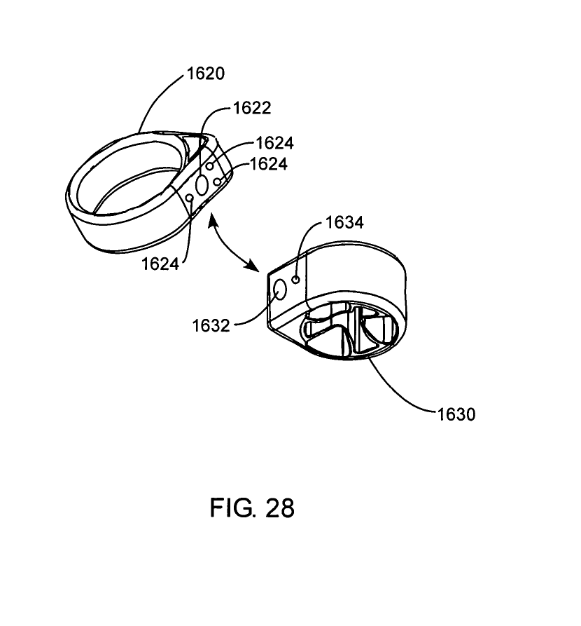

Furthermore, the dual magnet design, as discussed above, advantageously provides for better passive retention of the mating surfaces. Moreover, the alignment elements can have different positions on the coupler in order to allow adjustment of device in the passive support position. In yet another embodiment, as shown in FIG. 28, the hand piece 1620 can have a plurality of alignment magnets 1624 spaced about the attachment magnet 1622, and the coupler 1630 can have a single alignment magnet 1634 spaced apart from the attachment magnet 1632 so as to facilitate a plurality of passive support positions of the handheld implement as the coupler alignment magnet 1634 is selectively aligned with one of the plurality of alignment magnets 1624 on the hand piece 1620.

The present invention also provides for a method for storing a handheld implement on a hand of a user including attaching a hand ring to the user's hand. Similarly, a device ring can be attached to the handheld implement. A magnet in the hand ring can be coupled with a corresponding magnet in the device ring to magnetically attach the handheld implement to the user's hand. The device ring can be positioned with respect to the hand ring so that the handheld implement is positioned in a passive support position out of the way of the fingers on the user's hand. The device ring can be rotated with respect to the hand ring so as to position the handheld implement in an accessible position with respect to the fingers on the user's hand.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A hand based support device for holding a handheld implement on a user's hand, comprising:
a hand piece disposable on a user's hand including a magnetically attractable element; and
a coupler disposable on the handheld implement, including a magnetically attractable element magnetically coupleable with the magnetically attractable element of the ring and rotatable with respect to the ring to move the handheld implement between a usable position and passive support position.

2. The device of claim 1, wherein the hand piece includes a ring sizable to fit on a portion of the user's hand selected from the group consisting of a finger, and a thumb.

3. The device of claim 1, wherein one of the hand piece magnetically attractable element and the coupler magnetically attractable material is a magnet and the other is a magnetically attractable material selected from the group consisting of a ferrous metal, a magnetic metal, a magnet, and combinations thereof.

4. The device of claim 1, wherein the magnetically attractable element of the hand piece is a magnet and the magnetically attractable element of the coupler is a magnet, and the hand piece magnet and the coupler magnet are oriented to attract one another.

5. The device of claim 1, wherein the coupler is selected from the group consisting of a device ring sizable to fit on the handheld implement, a bracket adhesively coupleable onto the handheld implement, a shell substantially encasing the handheld implement made from a magnetically attractive material, and combinations thereof.

6. The device of claim 1, wherein the coupler further includes:
a) a self sizing device ring sizable to fit on the handheld implement; and
b) a magnet magnetically attachable to the magnetically attachable element on the hand ring.

7. The device of claim 6, wherein a magnet on the hand piece is oriented at an oblique angle with respect to an axis of the hand piece, the magnet on the device ring is oriented at an oblique angle with respect to an axis of the device ring, and the device ring can rotate on the hand piece so as to move the handheld implement between a position accessible to the user's fingers and the passive support position out of the way of the user's fingers.

8. The device of claim 1, wherein the hand piece includes a self sizing ring sizable to fit on one of the user's finger or the user's thumb.

9. The device of claim 1, wherein the coupler is disposable on a handheld implement selected from the group consisting of a pen, a pencil, a stylus, a laser pointer, a graphic tablet stylus, a touch-screen stylus, a scribe, a hand writing device, a stick disk, a remote control, a thumb drive, a flash memory drive, handheld medical devices, erasers, highlighters, markers, pen tablet stylus, and combinations thereof.

10. The device of claim 1, further comprising:
a) a magnetically attractable attachment element and a magnetically attractable alignment element disposed on the hand piece;
b) a magnetically attractable attachment element and a magnetically attractable alignment element disposed on the coupler;
c) the attachment element in the hand piece element being magnetically attachable to the attachment element in the coupler; and
d) the alignment element in the hand piece being magnetically alignable with the alignment element in the coupler so as to align the handheld implement associated with the coupler in the passive support position.

11. The device of claim 10, wherein the attachment element and the alignment element of the hand piece have opposite magnetic poles and the attachment element and the alignment element of the coupler have opposite magnetic poles such that when the hand piece and the coupler are coupled together the attachment elements magnetically attract one another and the alignment elements attract one another to align the coupler on the hand piece.

12. The device of claim 11, wherein the attachment elements have a greater attractive magnetic force than the alignment elements such that the coupler can be rotated about the attachment elements when coupled to the hand piece to misalign the alignment elements while maintaining magnetic coupling of the attachment elements.

13. The device of claim 1, wherein the hand piece includes a magnetically attractable attachment element and a plurality of magnetically attractable alignment elements, and the coupler includes a corresponding magnetically attractable attachment element and a magnetically attractable alignment element, the attachment element in the hand piece element being magnetically attachable to the attachment element in the coupler, and the alignment element in the coupler being selectively magnetically alignable with the one of the plurality of alignment elements in the hand piece so as to align the handheld implement associated with the coupler in one of a plurality of passive support positions.

14. A device for holding a handheld implement on a user's hand, comprising:
a primary magnetically attractable element disposable on a user's hand;
a secondary magnetically attractable element associable with a handheld implement; and
the secondary magnetically attractable element being magnetically coupleable to the primary magnetically attractable element so as to magnetically couple a handheld implement associated with the secondary magnetically attractable element to the primary attractable element.

15. The device of claim 14, wherein the secondary magnetically attractable element rotatably and removably couples the handheld implement to the primary magnetically attractable element with the secondary magnetically attractable element rotatable about the primary magnetically attractable element to position the handheld implement between a usable position engageable by the user's fingers and a passive support position out of the way of the user's fingers.

16. The device of claim 14, wherein the primary magnetically attractable element is disposed in a hand piece coupleable to the user's hand, the hand piece being selected from the group consisting of a ring sizable to fit on a finger of the user's hand, and a ring sizable to fit on a thumb of the user's hand.

17. The device of claim 14, further comprising:
a) a finger ring sizable to fit on a user's finger and having a recess for housing the primary magnetically attractable element; and
b) a device ring sizable to fit on a handheld device and having a recess for housing the secondary magnetically attractable element.

18. A hand based storage device for holding a handheld implement on a user's hand, comprising:
a finger ring sizable to fit on a user's finger;
a device ring sizable to fit on the handheld implement; and
a coupler operably coupling the device ring to the hand ring, and operable to rotate the handheld implement in the device ring between a usable position graspable by the user's fingers and passive support position out of the way of the user's fingers.

19. The device of claim 16, wherein the coupler is selected from the group consisting of a magnet on the hand ring and a magnetically attractive material on the device ring, a magnetically attractive material on the hand ring and a magnet on the device ring, a magnet on the hand ring and a magnet on the device ring, a biased tether extending between the hand ring and the device with the tether biased to position the hand ring in contact with the device ring when the user releases the handheld implement, and combinations thereof.

20. A method for storing a handheld implement on a hand of a user, comprising:
attaching a hand ring to a finger of the user's hand;
attaching a device ring to the handheld implement;
coupling a magnet in the hand ring with a corresponding magnet in the device ring to magnetically attach the handheld implement to the user's hand;
positioning the device ring with respect to the hand ring so that the handheld implement is positioned in a passive support position out of the way of the fingers on the user's hand; and
rotating the device ring with respect to the hand ring so as to position the handheld implement in an accessible position with respect to the fingers on the user's hand.
